(19) United States
(12) Patent Application Publication
(10) Pub. No.: US 2026/0101226 A1
(43) Pub. Date: Apr. 9, 2026

(54) METHODS, ARCHITECTURES, APPARATUSES AND SYSTEMS FOR ENHANCEMENT OF APPLICATION FUNCTION (AF) TRAFFIC INFLUENCE USING ENERGY RELATED INFORMATION

(71) Applicant: InterDigital Patent Holdings, Inc., Wilmington, DE (US)

(72) Inventors: Achref METHENNI, Montreal (CA); Michael Starsinic, Newtown, PA (US); Xavier De Foy, Kirkland (CA); Samir Ferdi, Kirkland (CA); Ulises Olvera-Hernandez, Saint-Lazare (CA); Saad Ahmad, Montreal (CA)

(21) Appl. No.: 18/905,870

(22) Filed: Oct. 3, 2024

(51) Int. Cl. H04W 28/02

(52) U.S. Cl. CPC H04W 28/0221

(57) ABSTRACT

Procedures, methods, architectures, apparatuses, systems, devices, and computer program products using wireless transmit/receive unit (WTRU) configured for receiving, from a second network node, a first request to obtain energy cost information associated with one or more data network access identifiers (DNAIs); sending, to a third network node, based on the first request, a second request to obtain the energy cost information associated with the one or more DNAIs; receiving, from the third network node, a response message comprising first information indicating energy cost associated with the one or more DNAIs; determining, based on the first information, a list of DNAIs from the one or more DNAIs; and sending, to the second network node, second information indicating the list of DNAIs.

### BACKGROUND

The present disclosure is generally directed to the fields of communications, software and encoding, including, for example, to methods, architectures, apparatuses, systems directed to traffic routing influence.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a procedure to process AF request to influence traffic routing;

FIG. 3 illustrates an example of an application function to request/subscribe to information related to DNAI energy cost, for energy aware traffic influence; and

FIG. 4 illustrates another example of a procedure to process AF request to influence traffic routing.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Provided below are acronyms/abbreviations for terms and phrases commonly used in this application:
5GS 5G System
5GC 5G Core
AF Application Function
AMF Access and Mobility Management Function
API Application
AS Application Server
DN Data Network
DNAI Data Network Access Identifier
DNN Data Network Name
EC Energy Cost
EE Energy Efficiency
EECF Energy Efficiency Control Function
ID Identifier
IP Internet Protocol
ML Machine Learning
MNO Mobile Network Operator
NEF Network Exposure Function
NWDAF Network Data Analytics Function
PCC Policy and Charging Control
PCF Policy Control Function
PDU Packet Data Unit
PSA UPF PDU Session Anchor UPF
QoS Quality of Service
SMF Session Management Function
S-NSSAI Single Network Slice Selection Assistance Information
UDR Unified Data repository
UE User Equipment
UP User Plane
Upf User Plane Function

Hereinafter, “a” and “an” and similar phrases are to be interpreted as “one or more” and “at least one”. Similarly, any term which ends with the suffix “(s)” is to be interpreted as “one or more” and “at least one”. The term “may”is to be interpreted as “may, for example”.

A symbol “/” (e.g., forward slash) may be used herein to represent “and/or”, where for example, “A/B”may imply “A and/or B”.

### Example Communications System

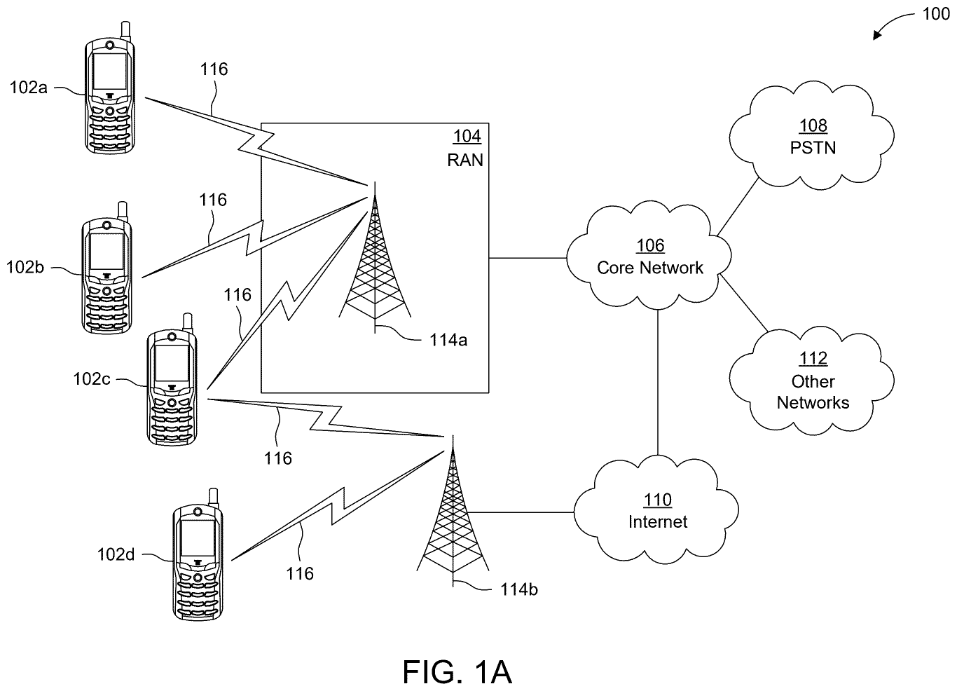

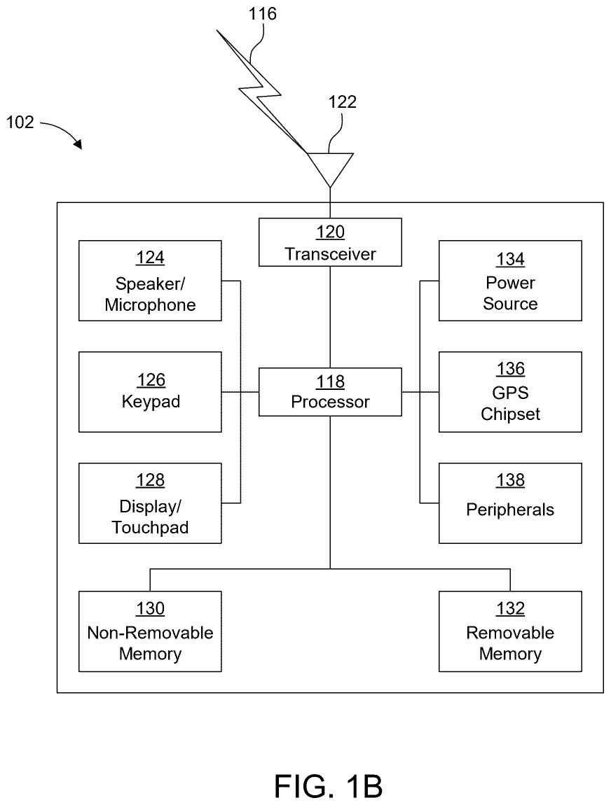

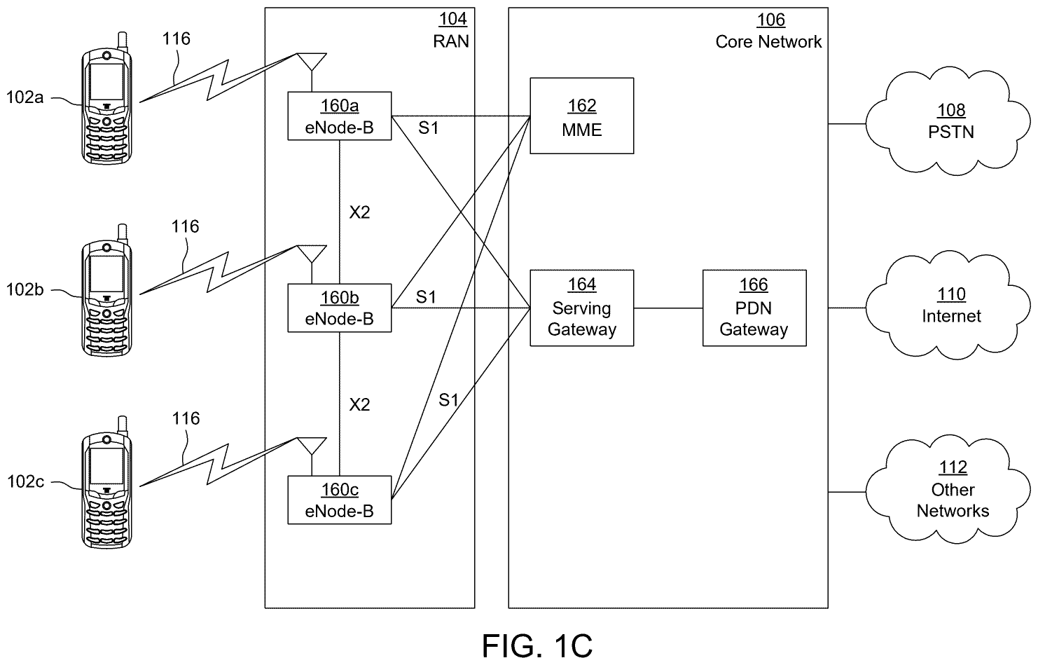

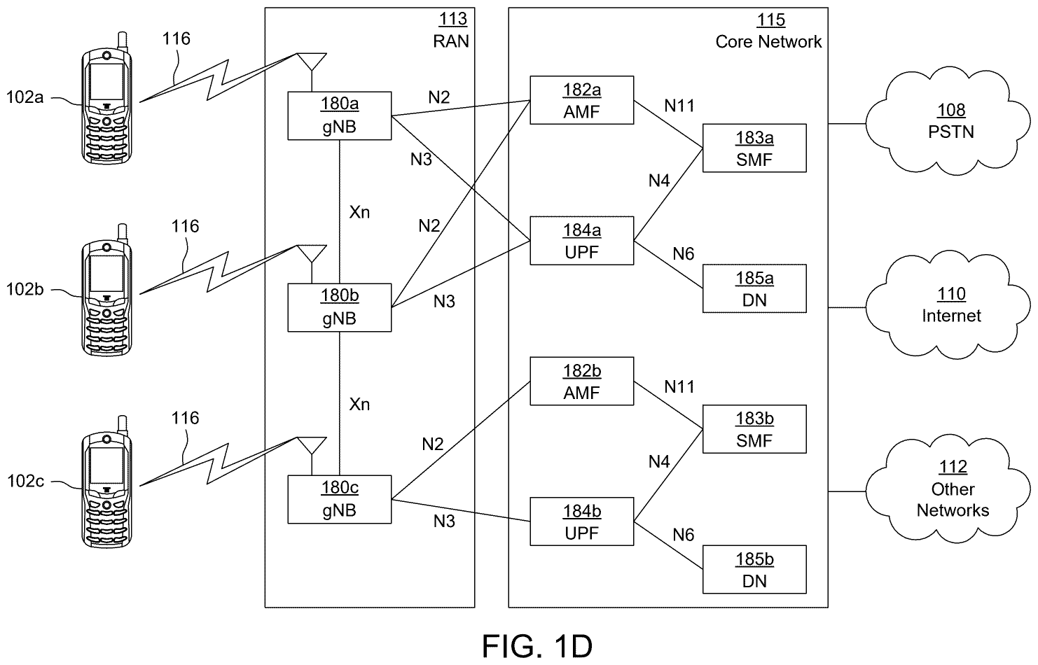

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

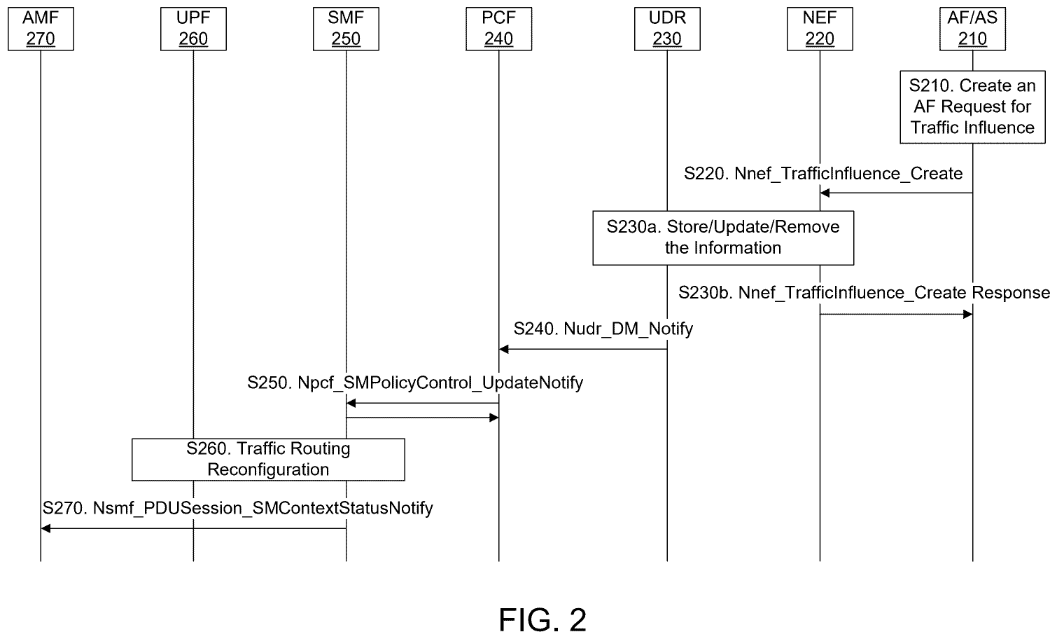

FIG. 2 illustrates a procedure to process AF request to influence traffic routing.

The procedure described allows the 5GS to support processing and provisioning application functions requests to influence traffic routing for a specific UE, for a specific PDU Session for a traffic of interest.

An AF 210 may create a request to influence traffic routing decisions. The AF may include the UE(s) of interest, N6 traffic routing information. N6 traffic routing information may include a DNAI(s), temporal and spatial validity conditions, possibility for application relocation, UE IP address preservation indication, subscription to UP path change events notifications, and UP latency requirement, among other information (step S210).

The AF 210 may send the request to the 5GS, e.g., using an NEF API (step S220).

The NEF 220 may receive the AF request, authorizes it (step S230b) and send it to the UDR 230 to store it (step S230a).

A PCF 240 that serves a PDU Session of interest may have subscribed to the UDR 230 to receive notification about AF request change, e.g., when a new AF request is authorized.

The UDR 230 may send a notification to the PCF 240 including the new AF request (step S240).

The PCF 240 may use the information associated with the AF request, including the N6 routing information to determine the N6 routing policies for the PDU Session that carries WTRU traffic. The N6 policies are included in PCC rule that are updated or generated by the PCF 240. The N6 rules may also include a list of (candidate) DNAI(s) and other parameters.

The PCF 240 may send the PCC rule including the new N6 routing policies to the SMF 250 serving the PDU Session of the WTRU (step S250). The SMF 250 may use the PCC rules to configure the UPF 260 with N6 traffic routing policies, and to setup actions at the SMF 250 such as UP path change event reporting to the AF 210. The SMF 250 may determine a target DNAI to use to serve the WTRU PDU Session (step S260).

The SMF 250 may have determined to reconfigure some routes and may perform UPF reselection.

Once the traffic routing is reconfigured, the SMF 250 may perform a PDU Session modification procedure to update the WTRU with the new information (step S270), for example via the AMF 270.

An application function is able to influence traffic routing decision in the 5GS using NEF services such as Nnef_TrafficInfluence service. The AF 210 may provide a list of DNAI(s) and routing Profile ID(s) or N6 traffic routing information and related parameters to the core network (e.g., 5GC) (e.g., the PCF 240).

A routing profile ID refers to a pre-agreed policy between the AF 210 and the core network (e.g., 5GC) and may refer to different steering policy IDs sent to SMF 250.

The traffic influence routing related parameters may include a User Plane latency requirement, a temporal validity condition, spatial validity condition. This information is used by the network (i.e., the SMF 250) to decide how to reconfigure the PDU Session. For example, the list of DNAI(s) can be used by the SMF 250 in a UPF reselection procedure. For example, the SMF 250 may select a new UPF to serve the PDU Session such that the new UPF is associated with the DNAI.

Currently, when the Application function requests to influence traffic routing for a certain traffic of interest, the AF 210 is not able to consider the energy aspect related to the routing information. For example, the AF 210 does not consider whether using a certain DNAI may incur more energy consumption or less energy efficiency on the 5GS or the UP path of the traffic. Thus, when the AF 210 considers which DNAI(s) to request the core network (e.g., 5GC) to select from, the AF 210 is not able to consider the impact of selecting each DNAI in terms of energy consumption.

Enhancements are therefore needed to allow the 5GS to facilitate the AF 210 to understand the energy cost related to using particular DNAI (i.e., UPF) and execute corresponding traffic routing decisions.

Additionally, the energy consumption/efficiency of a specific route or DNAI, may very likely depend on other traffic. For example, if a single data flow uses a first DNAI1 and 10 other data flows use another DNAI2, then it would be more efficient to move the single data flow to DNAI2. If there are no data flows using DNAI2, then using DNAI1 may be okay (especially if other flows are also using DNAI1). In such a scenario, it is beneficial take into account the traffic that is delivered to/from received other WTRUs towards the same data network.

It is proposed that the Application function, prior to sending a request to the 5GS for traffic routing influence, that the application function is able to request from the 5GS and obtain, energy information such as energy cost a specific WTRU using a specific DNAI may incur, or energy cost a specific PDU Session being moved to a specific DNAI may incur. The actual energy cost calculation will take into account other traffic routed through DNAIs.

The application function may leverage information related to energy cost for a specific WTRU using a specific DNAI, or the energy cost of moving a PDU Session to a specific DNAI to provide an energy informed Traffic influence routing request.

It is proposed that 5GS, e.g., the NWDAF, is able to provide analytics in the form of statistics or predictions related to the energy cost related to using specific DNAIs. The energy cost related to using a specific DNAI may include the energy cost of routing the traffic (e.g., PDU session traffic) through the router identified by the DNAI.

The AF may send a request to the NEF to obtain energy cost information related to a DNAI list that the AF may consider for traffic routing influence. The AF may use NEF traffic routing influence API. The AF may include the DNAI list of interest, energy cost related thresholds.

The NEF may receive a request from the AF for energy information about one or more DNAI(s).

The AF may be previously provisioned with the list of DNAI(s) and may use the DNAI(s) to route is application layer traffic. The AF is triggered to send the request when it determines that the DNAI(s) may be better suited to serve the application layer traffic that is associated with AF. For example, the AF determines that the application layer traffic will incur a shorter delay it may use one of the DNAI(s) compared to the DNAI that is currently being used.

The NEF may authorize the AF request and may perform a procedure with an NWDAF/EECF and may receive energy cost information for the DNAI(s). The NEF may use the energy cost information to categorize the list of DNAI(s), e.g., depending on their predicted energy consumption or energy efficiency. Categorizing may mean, for example, that the NEF assigns each DNAI to a high, medium or low category. Categorizing may mean, for example, that the NEF creates a list of the DNAI identities in order of predicted energy consumption from low to high.

The NEF may send the list of DNAI(s) and the categorization information to the AF.

An advantage of sending the categorization information and not the energy cost information to the AF is that the AF may be a 3rd party AF, and the MNO may not want to expose raw energy information to the 3rd party AF. For example, the raw energy information may not be understandable to the 3rd party AF and the raw energy information may related to internal network operations.

The AF may use the categorization information to select a DNAI. The AF may consider the categorization information and the network delay that is associated with each DNAI when determining which DNAI to select. The AF may provide the selected DNAI to the NEF and request that the PDU use the selected DNAI.

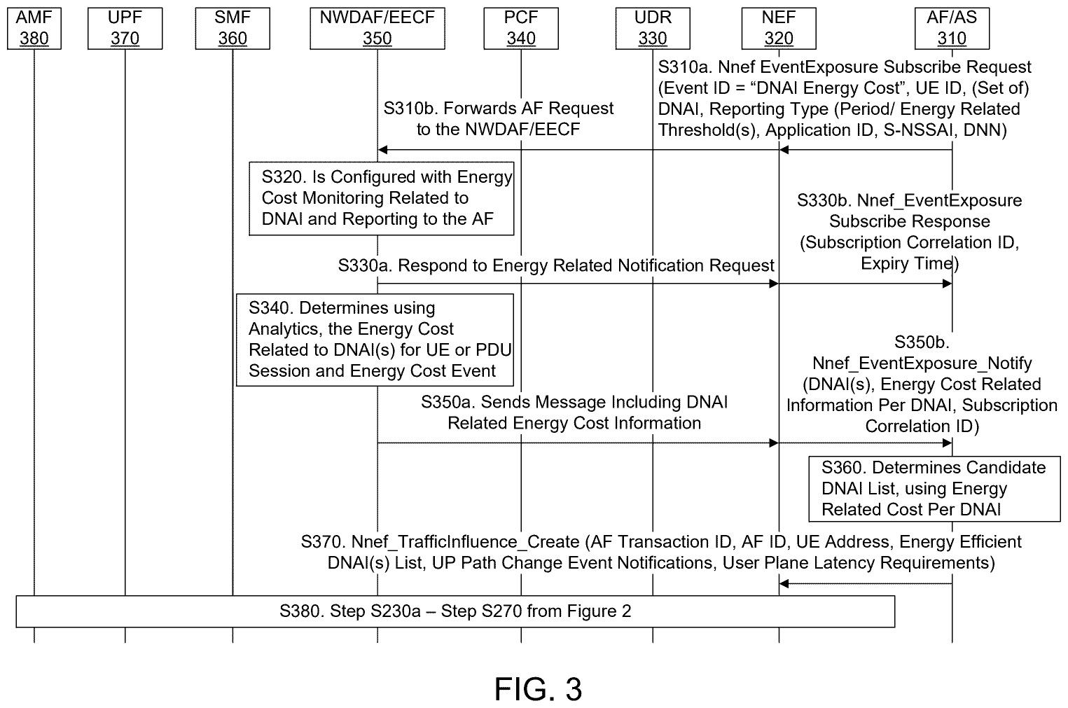

FIG. 3 illustrates a procedure wherein an application function requests/subscribes to information related to DNAI energy cost, for energy aware traffic influence.

A first network node 310 comprising an application function (e.g., AF) that is energy aware may decide to obtain energy cost information related to certain User plane path for certain Application server(s) and or DNAI(s).

In step S310a, the first network node 310 may send a request to the 5GS, e.g., via the second network node 320 (e.g., NEF), to obtain energy information related to certain user plane path(s), application server(s), and DNAI(s).

In fact, the application function may be interested to know for a certain data network, what is the energy cost related to exchanging data traffic between a WTRU and the Application server, via the different access points to that DN, using different DNAI(s) values, where each DNAI value identifies an access point to the DN.

The first network node 310 (e.g., AF) may request, for a certain WTRU ID, for a certain application ID, in a certain network slice, what would be the energy cost of using a specific DNAI to exchange the data between the WTRU and the AS.

The request may be for a certain WTRU that may exchange data traffic with the AS, with a group of WTRUs that may exchange data traffic with the Application server, or for any WTRU that may exchange data traffic with the AS.

The first network node 310 (e.g., AF) may request energy cost information that is specific to a certain application, if the there are multiple applications that are hosted on the AS. In this case, the first network node 310 (e.g., AF) may also include an application ID.

According to some embodiments, the first network node 310 (e.g., AF) may not include an application ID, if it is requesting the energy cost for all or any application hosted on the AS.

The first network node 310 (e.g., AF) may use a second network node 320 (e.g., NEF) API, such as Nnef_EventExposure_Subscribe request message to the second network node 320 (e.g., NEF). The first network node 310 (e.g., AF) may include a WTRU ID or group of WTRU ID (e.g., external group ID). The first network node 310 (e.g., AF) may also include an application ID, an S-NSSAI value. The first network node 310 (e.g., AF) includes DNN value.

The first network node 310 (e.g., AF) may include an event ID as “DNAI Energy cost” to indicate that it is requesting energy cost information related to DNAI(s) for the DN. The first network node 310 (e.g., AF) may include parameters describing the type of energy cost information requested (e.g., energy cost for the requested flows, energy efficiency class for the requested flows, total energy cost with/without the requested flows, energy recommendation indication). The first network node 310 (e.g., AF) may also include a list of DNAI(s) for which the energy cost information is requested.

The energy cost information may include the energy consumption in a certain time window, or average energy consumption, when a certain WTRU, are exchanging data traffic with the DN using a specific DNAI.

The energy cost information may include a total or average energy consumption for a group of WTRUs, average energy consumption per WTRU, when a certain DNAI is used.

The energy cost information may also include the energy efficiency of using a certain DNAI, when a certain WTRU or a group of WTRUs, exchange data traffic with the DN using the specific DNAI.

The energy cost information may include a current energy cost or status or for a future energy cost or status. For example, the first network node 310 (e.g., AF) may request the current energy consumption for a WTRU or a group of WTRUs, when connecting to a certain DN, using a specific DNAI value.

In another example, the first network node 310 (e.g., AF) may request information on how much it would cost, e.g., how much would the energy consumption be, if data traffic between a WTRU or group of WTRUs and the DN, is exchanged using the access point with DNAI value.

The energy cost information may include a total or average energy consumption for a group of WTRUs, average energy consumption per WTRU, when a certain DNAI is not used. In other words, this information describes the energy consumption before the requested traffic flows are routed through the DNAI.

The energy cost information may include a recommendation indication for a certain DNAI, e.g., a weight or priority value that indicates an energy-aware guidance by the 5GS, as described hereinafter.

The energy cost information may take into consideration the energy efficiency of the user plane path between the WTRU and the DNAI. For example, the higher the energy efficiency of the UP path, the lower the energy cost associated with the DNAI.

The first network node 310 (e.g., AF) may also include an indication whether periodic reporting for the energy cost information is needed. In that case, the first network node 310 (e.g., AF) includes a time period value. The first network node 310 (e.g., AF) may indicate that the request is a one-time request for the energy cost information related to the DNAIs.

The first network node 310 (e.g., AF) may indicate one or more threshold values for the energy cost information related to the DNAIs, for the event notification. For example, the first network node 310 (e.g., AF) may include certain categories of energy cost, and threshold value(s) for each category, and the first network node 310 (e.g., AF) may request that only DNAIs that are in a certain category, relative to the energy cost, is to be reported.

For example, the first network node 310 (e.g., AF) may provide three DNAI energy categories to the 5GS. A first category may be a “low energy cost” category, where a DNAI may belong to this category if the energy cost determined by the 5GS is below a first threshold Th1=5.

A second category may be “medium energy cost”, where a DNAI energy cost value is between Th1=5 and a second threshold Th2=20.

A third energy category may be “high energy cost”, where the DNAI energy cost value determined by the 5GS is above Th2=20.

In this case, the 5GS may provide to the first network node 310 (e.g., AF) only the DNAIs that are in a certain energy category, together with their energy cost information.

Additionally, the first network node 310 (e.g., AF) may request to be notified when the number of DNAIs that belong to a certain category are above or below a certain number.

For example, the first network node 310 (e.g., AF) may request to be notified when the number of DNAIs with “high energy cost” is more than 2 DNAIs. In this case, the first network node 310 (e.g., AF) may request to be provided with the energy cost information of these DNAIs.

In step S310b, the second network node 320 (e.g., NEF) may authorize the first network node 310 (e.g., AF) request.

The second network node 320 (e.g., NEF) may send request to the third network node 350 (e.g., NWDAF/EECF) to provide energy cost information for the DNAIs in the first network node 310 (e.g., AF) request.

In step S320, the second network node 320 (e.g., NEF) may use information received provided by the first network node 310 (e.g., AF) to determine the energy cost monitoring parameters (e.g., using whether the DNAI related energy cost is a one-time request or need to be reported on a periodic basis, in which case, the second network node 320 (e.g., NEF) may determine monitoring and reporting period).

The 5GS, e.g., the third network node 350 (e.g., NWDAF/EECF) may determine DNAI related energy cost information, which may include any of the following, for each DNAI: (1) the energy cost of transmitting the requested traffic flow(s) through the DNAI; (2) an energy cost class or energy efficiency class, (3) the total energy cost of the whole traffic routed through the DNAI, including the requested traffic flow(s); (4) the total energy cost of the whole traffic routed through the DNAI, excluding the requested traffic flow(s); or (5) a recommendation indication associated with the DNAI.

The energy cost of transmitting the requested traffic flow(s) through the DNAI (e.g., through border router(s) and link(s) identified with the DNAI), may be useful for the first network node 310 (e.g., AF) to determine the energy efficiency of selecting a DNAI. The energy cost may be an estimation based on the total energy usage (e.g., obtained from the border routers) and on the total traffic measurements and on an estimation or measurements of the request traffic usage.

An energy cost class or energy efficiency class, may be derived from the energy cost, as described hereinafter.

The total energy cost of the whole traffic routed through the DNAI, including the requested traffic flow(s) may correspond, for example, to the total energy consumption of the border router(s)).

The total energy cost of the whole traffic routed through the DNAI, excluding the requested traffic flow(s), may for example, enable identifying cases where the border router(s) are in low power mode, and therefore where routing the requested traffic flows through them would require them leaving low power mode.

A recommendation indication associated with the DNAI, e.g., a weight or priority associated with the DNAI. This can be used by a 5GS node (NWDAF/NEF) to suggest preferred DNAIs, for example based on detailed knowledge of the border routers energy management mechanisms, even in cases where energy measurements are not available or not precise. For example, the 5GS node could provide recommendation indications with the goal to use as little DNAIs as possible, while keeping the traffic usage through each DNAIs within a range known to be energy efficient.

The second network node 320 (e.g., NEF) may determine that the DNAIs are to be subject to a classification and determine the different energy related classes for the DNAIs. The second network node 320 (e.g., NEF) may use information provided by the first network node 310 (e.g., AF) to determine the different categories and their corresponding Energy cost level or range of values.

For example, the second network node 320 (e.g., NEF) may associate the class of low energy cost DNAI with an energy cost of 5 or below, the class of medium energy cost DNAI with an energy cost between 5 and 20, and a high energy cost DNAI with a threshold of energy cost 20.

The second network node 320 (e.g., NEF) may convert or map the energy cost requirement or threshold values into requirements or threshold values for the energy efficiency associated with the user plane between the WTRU and the DNAI(s) of interest.

For example, the second network node 320 (e.g., NEF) may associate the low energy cost DNAI class with a high energy efficiency DNAI and may determine that a DNAI may be labeled as a high EE DNAI if the EE associated with the UP between WTRU and DNAI has an energy efficiency value above a threshold Th1=0.6. The second network node 320 (e.g., NEF) may also determine that a high energy cost DNAI is a DNAI with lower energy efficiency, e.g., with EE value below a certain threshold value Th2=0.3

The second network node 320 (e.g., NEF) may use information from the first network node 310 (e.g., AF) to be configured to notify the first network node 310 (e.g., AF) when the number of DNAIs that belong to a certain energy cost class or energy efficiency class is above or below a certain value.

For example, if the number of DNAIs with low energy efficiency is 3 or more, the second network node 320 (e.g., NEF) may send a notification to the first network node 310 (e.g., AF) and may include the DNAIs with low EE and their EE value.

In step S330a and step S330b, the third network node 350 (e.g., NWDAF/EECF) responds to the request message for DNAI related energy cost information with a response message send to the first network node 310 (e.g., AF) via the second network node 320 (e.g., NEF), to confirm that the request is authorized and successfully configured. The third network node 350 (e.g., NWDAF/EECF) may include a correlation ID in the response message that can be used by the second network node 320 (e.g., NEF) and first network node 310 (e.g., AF) to identify which energy cost request the result is related to.

In step S340, the third network node 350 (e.g., NWDAF/EECF) may determine to estimate the energy cost information related to the DNAIs of interest.

The third network node 350 (e.g., NWDAF/EECF) may determine that analytics related to energy consumption, energy efficiency or energy cost of the DNAIs, need to be determined/obtained.

The third network node 350 (e.g., NWDAF/EECF) may determine/obtain such DNAI related energy analytics based on request from the first network node 310 (e.g., AF) via the second network node 320 (e.g., NEF).

The third network node 350 (e.g., NWDAF/EECF) may determine the type of energy related analytics that are needed (e.g., the energy efficiency and/or energy consumption for the UP between the WTRU and the DNAIs.

The third network node 350 (e.g., NWDAF/EECF) may determine whether statistical values of the analytics result, based on historical results, or a prediction of how the energy cost for each DNAI will be in the future (in a future time window) is needed.

The third network node 350 (e.g., NWDAF/EECF) may have an ML model ready for use in relation to the DNAI energy cost.

The third network node 350 (e.g., NWDAF/EECF) may determine predictions of the energy cost for the DNAIs or may determine the statistics for the energy cost, per DNAI.

In step S350a, the third network node 350 (e.g., NWDAF/EECF) may send a notification message, or a report to the second network node 320 (e.g., NEF). The notification message or report includes the energy cost information associated with the DNAIs from the DNAIs list. The report message may include for each DNAI, the estimated energy efficiency level, the energy consumption of the UP related to the path between WTRU and DNAI, an average energy consumption, and energy cost information, for each DNAI in the DNAIs list.

The second network node 320 (e.g., NEF) may filter and consolidate the obtained information.

The second network node 320 (e.g., NEF) may compare the DNAI energy cost predictions with the threshold values obtained from the first network node 310 (e.g., AF), to determine whether to include the DNAI in the list of candidate DNAIs to the first network node 310 (e.g., AF).

The second network node 320 (e.g., NEF) may use the analytics results for the DNAI energy cost, with the threshold values provided by the first network node 310 (e.g., AF), to determine the class of each DNAI, e.g., whether they are a high energy cost or low energy efficiency DNAI for the WTRU for the UP path of interest, and so on.

The second network node 320 (e.g., NEF) may also determine the number of DNAIs in each class of DNAIs and send the DNAIs in different classes depending on the reporting configuration (e.g., report the high energy cost DNAIs if their number is above 3).

In step S350b, the second network node 320 (e.g., NEF) may send to the first network node 310 (e.g., AF), the energy cost information related to all the DNAIs in the list provided by the first network node 310 (e.g., AF), so that the first network node 310 (e.g., AF) has the full information about the energy cost of each DNAI for the UP path of interest with the WTRU.

The second network node 320 (e.g., NEF) may send this information to the first network node 310 (e.g., AF), e.g., using the Nnef_EventExposure_Notify service operation.

In step S360, the first network node 310 (e.g., AF) may receive the energy cost information related to the DNAIs of interest.

The first network node 310 (e.g., AF) may use this information to determine a candidate DNAI list.

The first network node 310 (e.g., AF) may use an energy cost threshold and selects the DNAIs that have an associated energy cost this below this threshold to be in the candidate DNAIs.

If the first network node 310 (e.g., AF) was provided with an energy efficiency information, the first network node 310 (e.g., AF) may use an energy efficiency threshold value and select the DNAIs that have an estimated energy efficiency that is higher than the threshold value and be included in the candidate DNAI list.

The energy cost, energy consumption or energy efficiency reflect the energy cost related to the user plane path between the WTRU and the DNAI.

The 5GS may have an information or estimate about the energy cost of the path between the AS and a PSA UPF when a certain DNAI is used. This information may have been provided by the first network node 310 (e.g., AF) in step 310 in the request for energy cost estimate.

The 5GS may determine that for a certain DNAI, a different PSA UPF may be used to forward traffic between the WTRU and the AS through this DNAI. In this case, using different PSA UPF may impact the energy consumption or energy efficiency/cost of the UP path between the WTRU and AS or WTRU and the UPF.

The first network node 310 (e.g., AF) may use the energy cost provided by the second network node 320 (e.g., NEF)/third network node 350 (e.g., NWDAF/EECF), along with other local information to determine the candidate DNAI list for the WTRU and the traffic session of interest.

For example, the first network node 310 (e.g., AF) may have an estimate of the energy cost that each DNAI incurs or may incurs locally, when the UP traffic is exchanged between the WTRU and the AS across this DNAI and via the PSA UPF. This local energy cost may be related to the energy consumption for transmitting the traffic in the downlink through the DNAI to the UPF.

This local energy cost may reflect the energy consumption related to the processing of the UP traffic when the AS sends or receives it through the DNAI.

The local energy cost may be related to the current or expect load of the AS, e.g., computational load or energy load, when the UP traffic is exchanged between the WTRU and the AS through this DNAI takes place.

The first network node 310 (e.g., AF) may use the energy cost received from the second network node 320 (e.g., NEF)/third network node 350 (e.g., NWDAF/EECF) together with the local energy cost for each DNAI, to determine the total energy cost of the DNAIs and select the DNAIs that are the least energy costly.

For example, the first network node 310 (e.g., AF) may have received energy cost information from the second network node 320 (e.g., NEF)/third network node 350 (e.g., NWDAF/EECF), including DNAI1 having EC1=5, DNAI2 EC2=10, DNAI3 EC3=7 (for the WTRU and UP path of interest).

The first network node 310 (e.g., AF) has local energy cost information for the DNAIs including DNAI1 Local EC=6, DNAI2 Local EC=3, and DNAI3 Local EC=2.

Hence the first network node 310 (e.g., AF) may determine that the total energy cost Tot EC=11 for DNAI1, Tot EC=10 for DNAI2 and Tot EC=9 for DNAI3.

The first network node 310 (e.g., AF) may determine, using a threshold of 10 that DNAI2 and DNAI3 are candidate DNAIs for the traffic exchange for the UP session between the WTRU and the AS.

In step S370, in the case where the first network node 310 (e.g., AF) determines the DNAIs to include in the DNAI list, or a list of energy efficient DNAIs list, the first network node 310 (e.g., AF) may send a request to the core network (e.g., 5GC), to influence traffic routing for the application traffic of interest.

The first network node 310 (e.g., AF) may include WTRU address, and first network node 310 (e.g., AF) ID, and a first network node 310 (e.g., AF) transaction ID for the traffic routing influence request.

The first network node 310 (e.g., AF) may include the list of DNAIs that were determined based on the energy cost information provided by the core network (e.g., 5GC) and perhaps further processing by the first network node 310 (e.g., AF).

The first network node 310 (e.g., AF) may include an indication that the core network (e.g., 5GC) should notify the first network node 310 (e.g., AF) when a user plane path change took place.

In step S380, once the second network node 320 (e.g., NEF) may receive the first network node 310 (e.g., AF) request to influence traffic routing for the traffic of interest, the steps S230a to step S270 of procedure in FIG. 2 may be performed.

The first network node 310 (e.g., AF) may send the request to the 5GS, e.g., using an NEF API. The second network node 320 (e.g., NEF) may receive the first network node 310 (e.g., AF) request, authorizes it and send it to the fourth network node 330 (e.g., UDR) to store it. The fifth network node 340 (e.g., PCF) that serves a PDU Session of interest may have subscribed to the fourth network node 330 (e.g., UDR) to receive notification about AF request change, e.g., when a new AF request is authorized. The fourth network node 330 (e.g., UDR) may send a notification to the fifth network node 340 (e.g., PCF) including the new first network node 310 (e.g., AF) request. The fifth network node 340 (e.g., PCF) may use the information associated with the first network node 310 (e.g., AF) request, including the N6 routing information to determine the N6 routing policies for the PDU Session that carries WTRU traffic. The N6 policies are included in PCC rule that are updated or generated by the fifth network node 340 (e.g., PCF). The N6 rules may also include a list of (candidate) DNAI(s) and other parameters. The fifth network node 340 (e.g., PCF) may send the PCC rule including the new N6 routing policies to the sixth network node 360 (e.g., SMF) serving the PDU Session of the WTRU. The sixth network node 360 (e.g., SMF) may use the PCC rules to configure the seventh network node 370 (e.g., UPF) with N6 traffic routing policies, and to setup actions at the sixth network node 360 (e.g., SMF) such as UP path change event reporting to the AF. The sixth network node 360 (e.g., SMF) may determine a target DNAI to use to serve the WTRU PDU Session. The sixth network node 360 (e.g., SMF) may have determined to reconfigure some routes and may perform a reselection at the seventh network node 370 (e.g., UPF). Once the traffic routing is reconfigured, the sixth network node 360 (e.g., SMF) may perform PDU Session modification procedure to update the WTRU with the new information, for example via an eighth network node 380 (e.g., AMF).

According to some embodiments, once the second network node 320 (e.g., NEF) receive the energy cost information or energy report related to the DNAIs provided in the first network node 310 (e.g., AF) request, the second network node 320 (e.g., NEF) may consolidate the information, compare the energy cost to energy related thresholds, and classify the DNAIs depending on their energy class, and so on. The second network node 320 (e.g., NEF) may send the energy related information, after consolidation and further processing, to the first network node 310 (e.g., AF). The first network node 310 (e.g., AF) may use the energy related information for the DNAIs, and the additional information provided by the second network node 320 (e.g., NEF), to determine a list of candidate DNAIs, which are energy efficient or are suitable to the first network node 310 (e.g., AF).

According to some embodiments, the first network node 310 (e.g., AF) may send a request to the second network node 320 (e.g., NEF) to influence traffic. The first network node 310 (e.g., AF) may provide a list of DNAI candidates that may be considered for traffic routing. The first network node 310 (e.g., AF) may include an indication that an energy efficiency DNAI selection is preferred by the first network node 310 (e.g., AF) and can be considered. The second network node 320 (e.g., NEF) may authorize the first network node 310 (e.g., AF) request and may be triggered to query the third network node 350 (e.g., NWDAF/EECF) for DNAI energy cost information for the DNAI list that was provided by the first network node 310 (e.g., AF) request. Once the second network node 320 (e.g., NEF) receive the energy report that includes energy cost information for the DNAI list, the second network node 320 (e.g., NEF) may select a DNAI that is optimal in terms of energy efficiency, since the first network node 310 (e.g., AF) indicated that energy efficient DNAI selection is desirable. The second network node 320 (e.g., NEF) may send a response message to the first network node 310 (e.g., AF) to indicate the selected DNAI and may also provide the energy cost information for this DNAI.

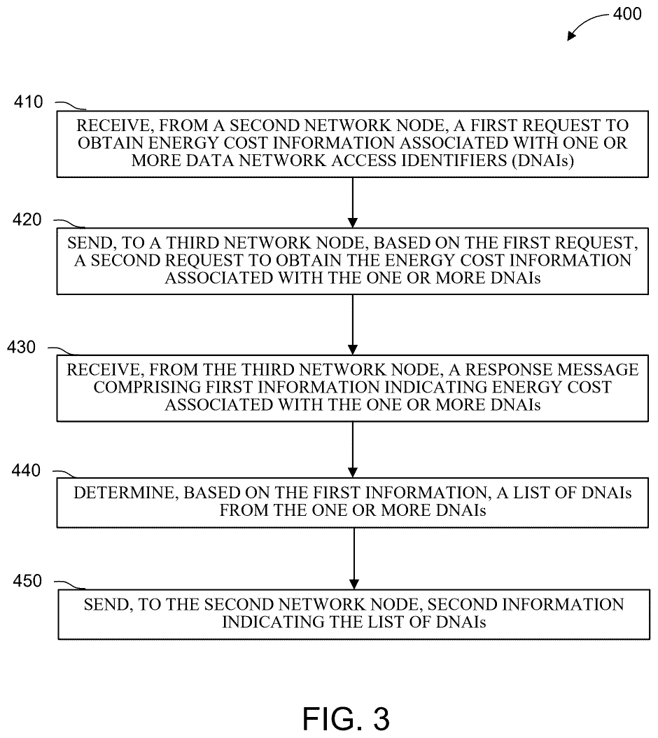

FIG. 4 illustrates an example of method 400, implemented by a first network node, to process AF request to influence traffic routing.

The first network node may receive, from a second network node, a first request to obtain energy cost information associated with one or more DNAIs (step 410).

The first network node may send, to a third network node, based on the first request, a second request to obtain the energy cost information associated with the one or more DNAIs (step 420).

The first network node may receive, from the third network node, a response message comprising first information indicating energy cost associated with the one or more DNAIs (step 430).

The first network node may determine, based on the first information, a list of DNAIs from the one or more DNAIs (step 440).

The first network node may send, to the second network node, second information indicating the list of DNAIs (step 450).

According to certain embodiments, the energy cost may be associated with data traffic between a WTRU and a fourth network node, wherein the fourth network node is associated with the one or more DNAIs.

According to certain embodiments, the energy cost may be associated with data traffic between the WTRU and the fourth network node for any of: (1) one or more application identifier, (2) one or more user plane paths, or (3) one or more network slices.

According to certain embodiments, the first information may indicate any of: (1) an energy consumption in a time window, (2) or an average energy consumption, (3) a prediction of an energy efficiency level, (4) a current energy cost, or (5) a future energy cost.

According to certain embodiments, the determination of the list of DNAIs from the one or more DNAIs may be based on a comparison of any of: (1) the current energy cost, or (2) a prediction of the future energy cost with an energy cost threshold value.

According to certain embodiments, the determination of the list of DNAIs from the one or more DNAIs may be based on a comparison of the energy efficiency level with an energy efficiency level threshold value.

According to certain embodiments, the second information may indicate any of: (1) a WTRU address, (2) an identifier associated with the third network node, or (3) a transaction identifier associated with a traffic routing.

According to certain embodiments, the first network node may be further configured to exchange data traffic between a WTRU and a fourth network node, wherein the fourth network node is associated with the list of DNAIs.

According to certain embodiments, the first network node may be configured to: based on the first information, obtain third information associated with the list of DNAIs with, wherein the third information may indicate a category of energy cost; and send, to the fourth network node, the third information.

According to certain embodiments, the first network node may comprise a network exposure function, the second network node may comprise an application function, the third network node may comprise a network data analytics function, and/or the fourth network node may comprise a user plane function.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method implemented in a first network node, the method comprising:
receiving, from a second network node, a first request to obtain energy cost information associated with one or more data network access identifiers (DNAIs);
sending, to a third network node, based on the first request, a second request to obtain the energy cost information associated with the one or more DNAIs;
receiving, from the third network node, a response message comprising first information indicating energy cost associated with the one or more DNAIs;
determining, based on the first information, a list of DNAIs from the one or more DNAIs; and
sending, to the second network node, second information indicating the list of DNAIs.

2. The method according to claim 1, wherein the energy cost is associated with data traffic between a wireless transmit/receive unit (WTRU) and a fourth network node, and wherein the fourth network node is associated with the one or more DNAIs.

3. The method according to claim 2, wherein the energy cost is associated with data traffic between the WTRU and the fourth network node for any of: (1) one or more application identifier, (2) one or more user plane paths, or (3) one or more network slices.

4. The method according to claim 1, wherein the first information indicates any of: (1) an energy consumption in a time window, (2) or an average energy consumption, (3) a prediction of an energy efficiency level, (4) a current energy cost, or (5) a future energy cost.

5. The method according to claim 4, wherein determining the list of DNAIs from the one or more DNAIs is based on a comparison of any of: (1) the current energy cost, or (2) a prediction of the future energy cost with an energy cost threshold value.

6. The method according to claim 4, wherein determining the list of DNAIs from the one or more DNAIs is based on a comparison of the energy efficiency level with an energy efficiency level threshold value.

7. The method according to claim 1, wherein the second information indicates any of: (1) a WTRU address, (2) an identifier associated with the third network node, or (3) a transaction identifier associated with a traffic routing.

8. The method according to claim 1, further comprising exchanging data traffic between a WTRU and a fourth network node, wherein the fourth network node is associated with the list of DNAIs.

9. The method according to claim 2, further comprising: based on the first information, obtaining third information associated with the list of DNAIs with, wherein the third information indicates a category of energy cost; and sending, to the fourth network node, the third information.

10. The method according to claim 2, wherein the first network node comprises a network exposure function, wherein the second network node comprises an application function, wherein the third network node comprises a network data analytics function, and/or wherein the fourth network node comprises a user plane function.

11. A first network node comprising circuitry, including a transmitter, a receiver, a processor and memory, the first network node configured to:
receive, from a second network node, a first request to obtain energy cost information associated with one or more data network access identifiers (DNAIs);
send, to a third network node, based on the first request, a second request to obtain the energy cost information associated with the one or more DNAIs;
receive, from the third network node, a response message comprising first information indicating energy cost associated with the one or more DNAIs;
determine, based on the first information, a list of DNAIs from the one or more DNAIs; and
send, to the second network node, second information indicating the list of DNAIs.

12. The first network node method according to claim 11, wherein the energy cost is associated with data traffic between a wireless transmit/receive unit (WTRU) and a fourth network node, and wherein the fourth network node is associated with the one or more DNAIs.

13. The first network node according to claim 12, wherein the energy cost is associated with data traffic between the WTRU and the fourth network node for any of: (1) one or more application identifier, (2) one or more user plane paths, or (3) one or more network slices.

14. The first network node according to claim 11, wherein the first information indicates any of: (1) an energy consumption in a time window, (2) or an average energy consumption, (3) a prediction of an energy efficiency level, (4) a current energy cost, or (5) a future energy cost.

15. The first network node according to claim 14, wherein the determination of the list of DNAIs from the one or more DNAIs is based on a comparison of any of: (1) the current energy cost, or (2) a prediction of the future energy cost with an energy cost threshold value.

16. The first network node according to claim 14, wherein the determination of the list of DNAIs from the one or more DNAIs is based on a comparison of the energy efficiency level with an energy efficiency level threshold value.

17. The first network node according to claim 11, wherein the second information indicates any of: (1) a WTRU address, (2) an identifier associated with the third network node, or (3) a transaction identifier associated with a traffic routing.

18. The first network node according to claim 11, further configured to exchange data traffic between a WTRU and a fourth network node, wherein the fourth network node is associated with the list of DNAIs.

19. The first network node according to claim 12, further configured to: based on the first information, obtain third information associated with the list of DNAIs with, wherein the third information indicates a category of energy cost; and send, to the fourth network node, the third information.

20. The first network node according to claim 11, wherein the first network node comprises a network exposure function.
